(19) United States
(12) Patent Application Publication
(10) Pub. No.: US 2004/0189247 A1
(43) Pub. Date: Sep. 30, 2004

(54) Power source adapter for battery-operated devices

(76) Inventors: Graeme Burman, Sterling, VA (US); Todd Molland, Sterling, VA (US)

Correspondence Address: Steven B. Pokotilow, Esq., Stroock & Stroock & Lavan LLP, 180 Maiden Lane, New York, NY, 10038, US

(21) Appl. No.: 10/400,512

(22) Filed: Mar. 27, 2003

(51) Int. Cl. H02J 7/00

(52) U.S. Cl. 320/112

(57) ABSTRACT

A power source adapter that provides continuous power to a battery-operated device including a casing substantially in the shape of a conventional battery, a first positive terminal electrically connected to an external power source, a first negative terminal electrically connected to the external power source where the power source provides continuous electrical power to the first positive and negative terminals.

### FIELD OF THE INVENTION

The present invention relates to a power source adapter that can be placed inside the battery compartment of any battery-operated device.

### BACKGROUND OF THE INVENTION

Many modern devices are battery operated, such as toys, flashlights, electronic games and other gadgets. Manufacturers, distributors, dealers, and the like of such battery-operated devices often present these products at various public forums, for example, at trade shows, demonstration booths in retails stores, and at corporate promotional events. The constant display and use of battery-operated devices creates a continuous need to replace batteries contained in these devices. This need, in turn, can represent a significant expense involved with the regular purchase of various size fresh batteries to have on hand to replace spent batteries. In addition, there is the loss of time and annoyance of constantly having to replace the batteries in devices that are running for long periods of time while on display or demonstration.

It can therefore be appreciated that there exists a need for a continuous source of direct current power that can easily be placed in the battery compartment of a battery-powered device as a substitute for conventional batteries. The present invention solves these and other problems by providing a convenient continuous source of power for battery-operated devices.

Accordingly, it is an object of the present invention to avoid the time and cost of continuously purchasing fresh batteries to replace spent batteries while battery-operated devices are in use, such as, for example, during extended demonstration or display applications. It is a further object of the present invention to avoid the time and annoyance of constantly replacing spent batteries on such devices.

It is a further object of the present invention to avoid the time and cost to manufacture modified “display versions” of simple battery-operated devices that will operate on conventional AC power.

Other objects and features of the present invention will become apparent from the following detailed description, considered in conjunction with the accompanying drawing figures. It is to be understood, however, that the drawings are designed solely for the purpose of illustration and not as a definition of the limits of the invention, for which reference should be made to the appended claims.

The present invention achieves its intended purposes, objects, and advantages through a new, useful, and unobvious combination of component elements, with the use of a minimum number of functioning parts, at a reasonable cost to manufacture, and by employing readily available materials.

### SUMMARY OF THE INVENTION

The present invention is directed to a power source adapter for battery-operated devices. In particular, the present invention is directed towards a power source adapter in the shape of one or more conventional size batteries, the adapter being electrically coupled to the DC output of a AC/DC converter to provide a constant source of DC power to a battery-operated device.

In a preferred embodiment, the power source adapter of the present invention comprises a casing in the shape of one or more conventional batteries such that one or more of the adapters can be readily place in the battery compartment of a battery-operated device. The outer casing partially encloses a pair of positive and negative terminals for direct current power input fed from an external source, such as an AC/DC converter, and a second pair of positive and negative terminals that provide the direct current power output to the battery-operated device.

The power source adapter of the present invention provides a convenient way to provide a source of constant direct current power to run battery-operated devices and is especially useful for providing continuous power for those devices that are operated for extended periods of time, without the need to replace spent batteries.

As will become evident from the description below, one skilled in the art will appreciate that minor modifications to the embodiments described can be made as a matter of design-specific choice without departing from the spirit of the invention.

### BRIEF DESCRIPTION OF THE DRAWINGS

The drawing figures are not to scale and are merely illustrative, wherein like reference characters denote similar elements throughout the several views:

FIG. 1 is a perspective view of a power source adapter constructed in accordance with a first preferred embodiment of the present invention;

FIG. 2 is a cross-sectional perspective view of the power source adapter of FIG. 1

FIG. 3 is a perspective view of the power source adapter of FIG. 1 coupled to an AC/DC converter as an external power in accordance with a first preferred embodiment of the present invention; and

FIG. 4 is a perspective view of a power source adapter of FIG. 1 constructed in accordance with a second preferred embodiment of the present invention.

### DETAILED DESCRIPTION OF THE PREFERRED EMBODIMENTS

The present invention relates to a power source adapter capable of providing a constant source of direct current power to a battery-operated device. In particular, the present invention is directed towards a power source adapter that can be inserted into the battery compartment of battery-operated devices, thereby providing a continuous power source for a battery-operated device, and thereby obviating the need to constantly replace spent batteries after prolonged use of the device.

In this respect, before describing one embodiment of the invention, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

For example, as will be further described below, the power source adapter of the present invention is not limited to be used in place of any particular type or number of batteries. Specific, non-limiting examples of such battery configurations that the present invention can be adapted to include, but are not limited to, “AAA,” “AA,” “C,” “D,” and nine-volt size batteries and the like, or any multiple types of these batteries used together.

In general terms, the power source adapter of the present invention comprises an outer casing in the shape of one or more conventional size batteries. The outer casing partially encloses two pairs of positive and negative terminals, thereby making the terminals accessible for electrical contact from both inside and outside the casing. The first positive terminal is electrically coupled to the second positive terminal through a conducting material, for example, a wire or metal plate contained inside the casing. Similarly, the first negative terminal is electrically coupled to the second negative terminal inside the casing in the same fashion.

In the present invention, the second positive and negative terminals are positioned in the same location as the positive and negative terminals, respectively, on a conventional battery for which the adapter is to be used for. For example, in the embodiment of the present invention whose casing is adapted to the cylindrical shape of a single “AA” size battery, the second positive terminal would be located at one end of the cylindrical casing and the second negative terminal would be located at the opposite end of the cylindrical casing, thereby permitting electrical contact with the battery-operated device in the same method as the conventional “AA” battery. Similarly, in an alternate embodiment of the present invention whose casing is adapted to the rectangular shape of a nine-volt battery, the second positive and negative terminals of the present invention would be located side by side at the top of the casing, thereby permitting electrical contact with the battery-operated device in the same method as the conventional nine-volt battery.

In the present invention, the portion of the first positive terminal that is externally accessible outside the casing 150 is also electrically coupled to the positive output of an external source of DC power, such as an AC/DC converter. Similarly, in the present invention, the portion of the first negative terminal that is externally accessible outside the casing 150 is also electrically coupled to the negative output of an external source of DC power, such as an AC/DC converter. AC/DC converters are well known in the art and are manufactured to provide direct current output at different voltage levels.

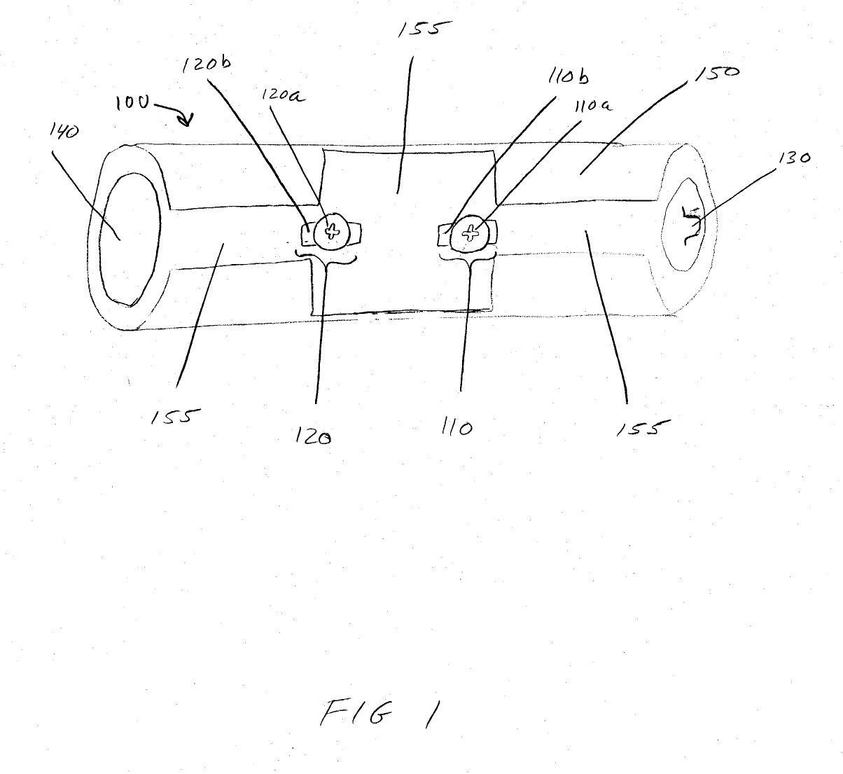

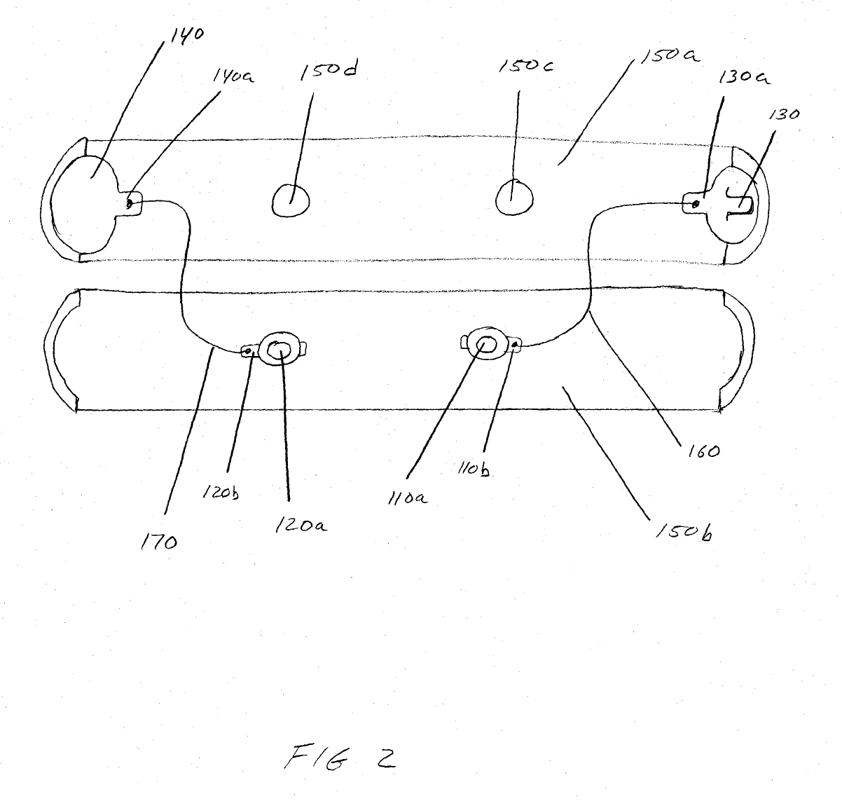

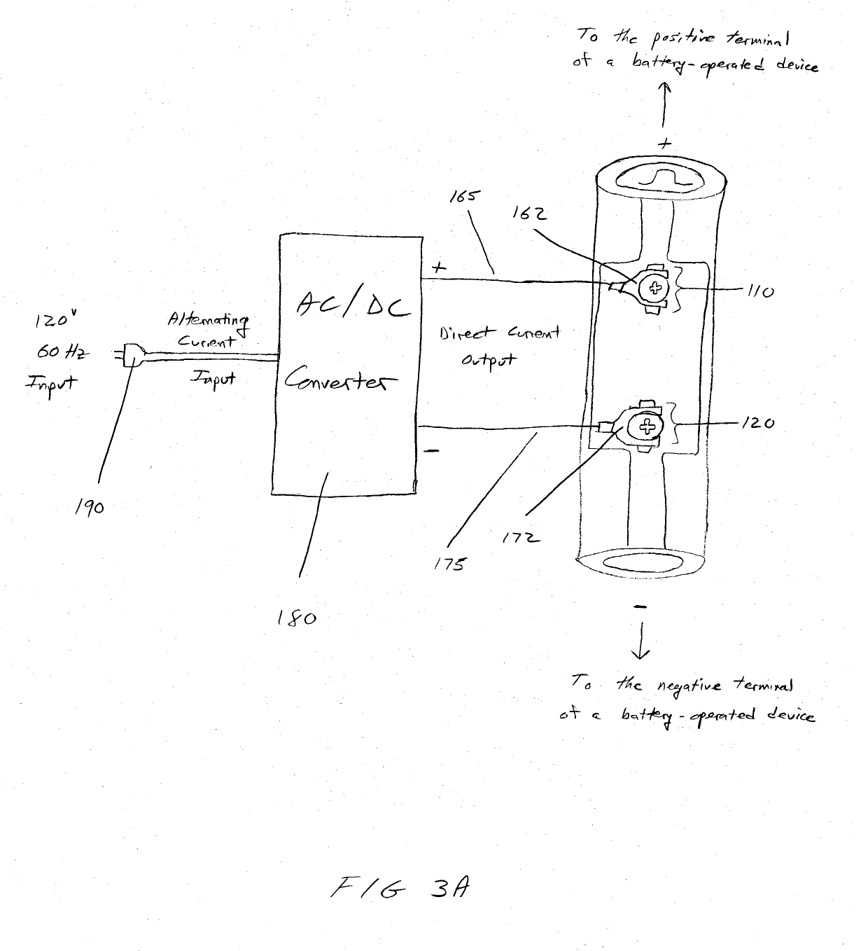

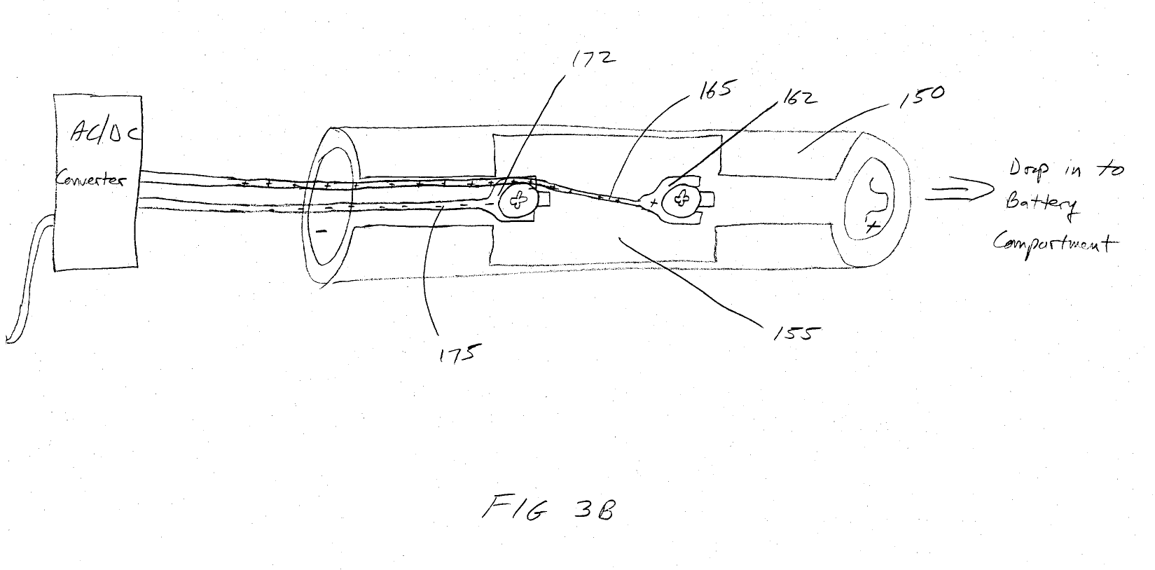

In the first preferred embodiment of the present invention, as seen in FIG. 1, in general terms, the power source adapter 100 comprises a casing 150 in the shape of, and with the approximate dimensions of, a conventional cylindrical battery, such as a size “AAA,” “AA,” “C,” or “D” battery. The casing 100 partially encloses a first positive terminal 110, a first negative terminal 120, a second positive terminal 130, and a second negative terminal 140. In a preferred embodiment, the first positive terminal 110 comprises a first screw 110a and a positive conducting plate 110b, which, in a preferred embodiment, protrude from the casing 150. As will be described in greater detail below with reference to FIG. 2, the positive conducting plate 110b is electrically coupled to the second positive terminal 130 through a conductor 160. By inserting an external positive connector 162 (shown in FIGS. 3A and 3B) between first screw 110a and positive conducting plate 110b, and tightening the first screw 110a, an electrical connection between the external positive connector 162 and the positive conducting plate 110b can be created.

Similarly, in a preferred embodiment, the first negative terminal 120 is comprised of a second screw 120a and a negative conducting plate 120b which, in a preferred embodiment, protrude from the casing 150. The negative conducting plate 120b is electrically coupled to the second negative terminal 140 through a conductor 170, as shown in FIG. 2. By inserting an external negative connector 172 (shown in FIGS. 3A and 3B) between the second screw 120a and the negative conducting plate 120b, an electrical connection between the external negative connector 172 and the positive conducting plate 120b can be created.

Of course, screw-type connections 110, 120 described above are but one method of making electrical connections. Other methods of establishing secure electrical connections may also be used in the present invention without departing from the spirit of the invention, including, but not limited to, crimp-type connectors, clamp connectors, solder connections, and the like.

In this first preferred embodiment of the present invention, the casing 150 also partially encloses a second positive terminal 130 that protrudes at one end of the casing 150 where the second positive terminal 130 can make electrical contact with the positive terminal of the battery compartment of the battery-operated device (not shown). As will be discussed in greater detail below with reference to FIG. 2, the second positive terminal 130 is electrically coupled to the first positive terminal 110 inside the casing 150.

Similarly, in the first preferred embodiment of the present invention, the casing 150 also partially encloses a second negative terminal 140 at the opposite end of the casing 150 where the second negative terminal 140 can make electrical contact with the negative terminal of the battery compartment of the battery-operated device (not shown). As will be discussed in greater detail below with reference to FIG. 2, the second negative terminal 140 is electrically coupled to the first negative terminal 120 inside the casing 150. In a preferred embodiment, terminals 130 and 140 are shaped as the positive and negative terminals respectively, on a conventional battery.

The internal schematic of the power source adapter 100 in the first preferred embodiment of the present invention will now be described in greater detail with reference to FIG. 2. In FIG. 2, the casing 150 is shown opened in a cross-sectional view. For illustration purposes, the top half 150a of the casing 150 is shown securing the second positive terminal 130 on one end of the top half 150a of the casing 150 and the top half 150a of the casing 150 is also shown securing the second negative terminal 140 at the opposite end of the top half 150a of the casing 150. Other arrangements are envisioned without departing from the spirit of the invention.

In this first preferred embodiment, the second positive terminal 130 includes a positive tab 130a onto which one end of a positive conductor 160 is electrically coupled thereto. In a preferred embodiment, the positive conductor 160 is an insulated wire. Also in a preferred embodiment, the connection between the one end of the positive conductor 160 and the positive tab 130a is a solder connection. Other electrical connections, however, may also be utilized, including electrical connections directly between the second positive terminal 130 and the positive conductor 160, without the need for a positive tab 130a. The other end of the positive conductor 160 is electrically coupled to the positive conducting plate 110b, thereby establishing an electrical connection between the first positive terminal 110 and the second positive terminal 130.

Similarly, in this first preferred embodiment, the second negative terminal 140 includes a negative tab 140a onto which one end of a negative conductor 170 is electrically coupled thereto. In a preferred embodiment, the negative conductor 170 is an insulated wire. Also in a preferred embodiment, the connection between the one end of the negative conducting material 170 and the negative tab 140a is a solder connection. Other electrical connections, of course, may also be utilized, including electrical connections directly between the second negative terminal 140 and the negative conductor 170, without the need for a negative tab 140a. The other end of the negative conducting material 170 is electrically coupled to the portion of the negative conducting plate 120b that is contained inside the casing 150, thereby establishing an electrical connection between the first negative terminal 120 and the second negative terminal 140.

In this first preferred embodiment of the present invention, the top half 150a of the casing 150 also contains two threaded cavities 150c and 150d that receive the first screw 110a and the second screw 120a when the top half 150a and the bottom half 150b are joined to form the casing 150. As discussed above, other methods of construction may also be utilized to establish the electrical connections between the first and second terminals that do not require the use of screws or cavities. For example, crimp connections may be used to complete the electrical path between the terminals. Furthermore, in the first preferred embodiment of the present invention described above, the first screw 110a and the second screw 110b keep the two halves of the casing 150 together when the top half 150a and 150b are joined. Other methods of joining the two halves of the casing 150 may also be used, for example, glue, snap connectors, or separate screws.

FIG. 3A depicts the power source adapter of the present invention with an external power source providing constant positively-charged direct current to the first positive terminal 110 and constant negatively-charged direct current to the first negative terminal 120. In a preferred embodiment, in accordance with the present invention, the external power source is an AC/DC converter 180. The AC/DC converter 180 has a positive output 165 that is electrically coupled to the first positive terminal 110 of the power source adapter 100. Similarly, the AC/DC converter 180 has a negative output terminal 175 that is electrically coupled to the first negative terminal 120 of the power source adapter 100.

AC to DC converters, also referred to as phase-controlled converters, are well known in the art. Generally, these devices convert an input of an alternating voltage, such as the common 120 v, 60 Hz voltage of a conventional electrical outlet in the United States, to an output of a DC voltage that can be varied based on electronic circuit design. The operation of AC/DC converters is beyond the scope of this disclosure, however, it is to be understood that the method of converting AC current to DC current can be varied as a matter of design choice using components now known or hereafter developed. Thus, the ultimate method of delivery of DC power to the power source adapter of the present invention is not to be considered restrictive to the practice of the present invention.

In a preferred embodiment, with reference to FIGS. 3A, the specific AC/DC converter 180 is selected to deliver the proper constant output voltage and direct current for the particular application of the power source adapter of the present invention, i.e., the output voltage and current of the AC/DC converter is selected to be the same as that of a fresh conventional battery or batteries for which the power source adapter is being substituted for in the battery-operated device. In a preferred embodiment, the input of the AC/DC converter 180 is 120 volt, 60 Hz AC power supplied via an insulated wire with a plug 190.

In a preferred embodiment, the casing 150 contains a flat groove portion 155 extending from one end of the casing 150 to the other where the first positive terminal 110 and the first negative terminal 120 are located. As shown in FIG. 3B, the flat groove portion 155 of the casing 150 provides space to run a set of thin positive and negative external leads 165, 175 (shown FIG. 3B) to be connected to the first positive terminal 110 and the first negative terminal 120 of the power source adapter 100. This feature of the present invention can be used in devices that contain “drop-in” battery compartments, where it would be impracticable to run the external leads 165, 175 in any other direction.

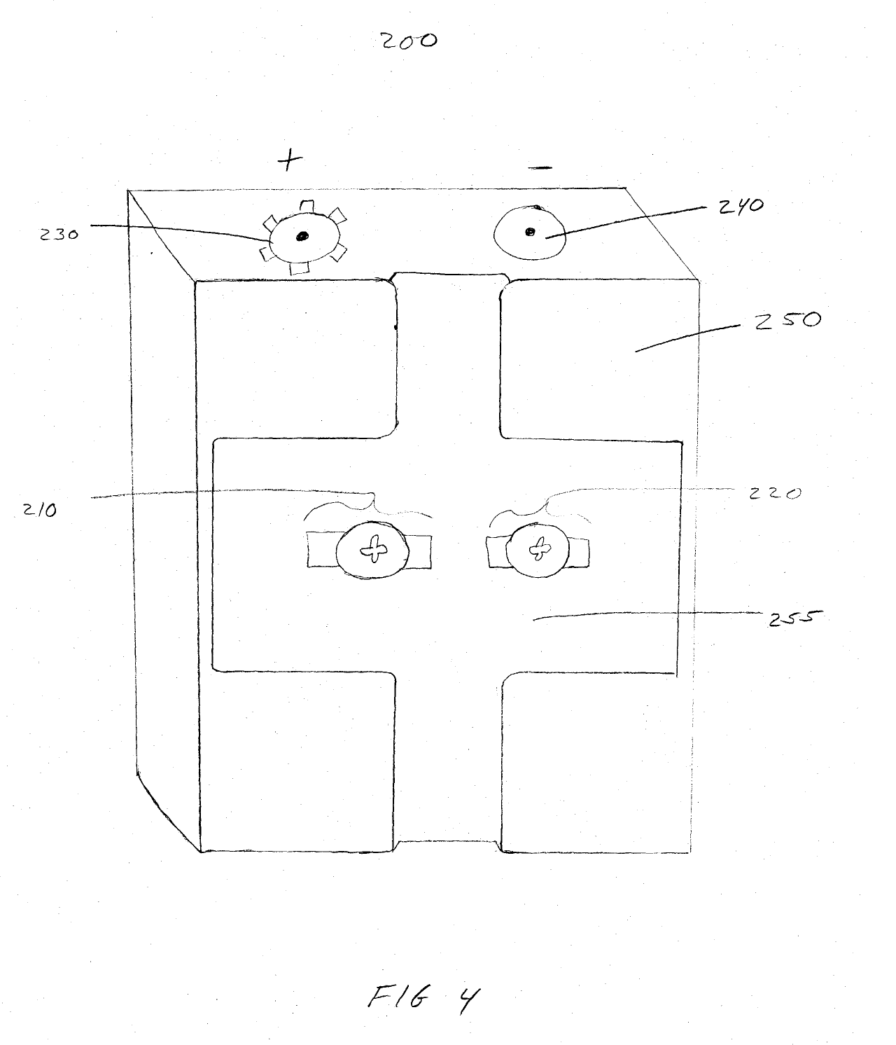

As described above, the casing 150 of the power supply adapter 100 can take any number of shapes and sizes to fit various battery configurations that may be utilized in the battery compartment of a battery-operated device. For example, FIG. 4 depicts a second preferred embodiment of the present invention wherein the casing 250 is adapted for use in a nine-volt battery compartment. Specifically, with reference to FIG. 4, the casing 250 is manufactured with the approximate shape and dimensions of a nine-volt battery. The casing 250 partially encloses a first positive terminal 210 and a first negative terminal 220. In this preferred embodiment, the first positive terminal 210 and first negative terminal 220 are accessible from the front face of the casing 250. The casing 250 also partially encloses a second positive terminal 230 and a second negative terminal 240. In this second preferred embodiment of the present invention, the second positive terminal 230 and the second negative terminal 240 are located at the top of the casing 250 in the same position as the positive and negative terminals in a conventional nine-volt battery. In this second preferred embodiment of the present invention, the first positive terminal 210 is electrically coupled to the second positive terminal 230 in the same way as in the first preferred embodiment shown in FIG. 2. Similarly, the first negative terminal 220 is electrically coupled to the second negative terminal 240 in the same way as in the first preferred embodiment shown in FIG. 2.

As one skilled in the art will recognize, FIGS. 1 through 4 of the present invention depict only a few of the many possible embodiments of the present invention. As such, those skilled in the art will appreciate that the conception, upon which this disclosure is based, may readily be utilized as a basis for designing other structures, methods, and systems for carrying out one or more of the several purposes of the present invention. It is important, therefore, that the claims be regarded as including such equivalent constructions insofar as they do not depart from the spirit and scope of the present invention.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention, which, as a matter of language, might be said to fall there between. In particular, this invention should not be construed as being limited to the dimensions, proportions or arrangements disclosed herein.

What is claimed is:

1. A power source adapter for providing continuous power to a battery-operated device, said adapter comprising:
a casing substantially in the shape and size of a conventional battery;
a first positive terminal electrically coupled to an external power source, and
a first negative terminal electrically coupled to said external power source;
said external power source connectable to a conventional electrical outlet and adapted to provide appropriate continuous electrical power to said first positive and negative terminals.

2. The adapter of claim 1, wherein said adapter contains a second positive terminal that is electrically coupled to said first positive terminal.

3. The adapter of claim 1, wherein said adapter contains a second negative terminal that is electrically coupled to said first negative terminal.

4. The adapter of claim 1, wherein said external power source is an AC to DC converter.

5. The adapter of claim 1, wherein said casing is substantially in the shape and size of a “AAA” battery;

6. The adapter of claim 1, wherein said casing is substantially in the shape and size of a “AA” battery;

7. The adapter of claim 1, wherein said casing is substantially in the shape and size of a “C” battery;

8. The adapter of claim 1, wherein said casing is substantially in the shape and size of a “D” battery;

9. The adapter of claim 1, wherein said casing is substantially in the shape and size of a nine-volt battery.
